(19) United States
(12) Patent Application Publication
(10) Pub. No.: US 2011/0180201 A1
(43) Pub. Date: Jul. 28, 2011

(54) METHOD FOR PRODUCING AN OUTER LIMITING ELEMENT FOR A SLIDING BOARD BODY AND METHOD FOR PRODUCING A SLIDING BOARD BODY EQUIPPED THEREWITH

(75) Inventors: Rupert Huber, Radstadt (AT); Helmut Holzer, St. Johann (AT); Georg Klausner, St. Johann (AT)

(73) Assignee: ATOMIC AUSTRIA GMBH, Altenmarkt Im Pongau (AT)

(21) Appl. No.: 13/014,348

(22) Filed: Jan. 26, 2011

(30) Foreign Application Priority Data
Jan. 27, 2010 (AT) GM 47/2010

(51) Int. Cl. B32B 38/10; B32B 37/18

(52) U.S. Cl. 156/154; 156/306.6; 156/267

(57) ABSTRACT

The invention relates to a method for producing an outer limiting element for a sliding board body, such as a ski or a snowboard, and a method for producing a sliding board body equipped with said limiting element. The limiting element is formed by a one-piece part component composed of at least one cover layer and at least one part of the strengthening top band. The limiting element is then connected in a subsequent method step to the additional components of the sliding board body, such as its running surface and its strengthening lower band. It is essential in this case that the limiting element prior to connection with the additional components of the sliding board body is connected to at least one strip-like side wall element forming a lateral wall section of the sliding board body, in that the at least one strip-like side wall element is adhered to at least one longitudinal side edge of the cover layer or to the top band arranged on the lower side of the cover layer. The corresponding production method enables as far as possible an inexpensive and error-free production sequence for creating a high quality sliding board body with combined shell and side wall construction.

### BACKGROUND OF THE INVENTION

The invention relates to a method for producing an outer limiting element for a sliding board body, such as a ski or a snowboard, and a method for producing a sliding board body, in which said outer limiting element is used, as described in claims 1 and 10.

In EP 0 850 785 B1 a method of production is described for a multi-layered composite body in the form of a ski, snowboard or roll board. In this case an outer decoration complex for the composite body is prefabricated and said prefabricated decoration complex is joined afterwards together with the actual and/or supportable reinforcing structure of the composite body. The connection between the decoration complex and the reinforcing structure is performed in this case on the basis of a heat-fusible resin during a hot pressing cycle. The multilayered, prefabricated decoration complex comprises in this case a layer made of transparent or translucent plastic printed on the rear with sublimable inks. Said printed plastic layer is adhered with the aid of an adhesive film for hot assembly to an optical contrast film, whereby between said contrast film and the transparent, outer plastic layer a mesh is embedded. With these measures the flow or creep of the adhesive film during the hot pressing procedures is avoided, so that the print colors remain in their respective place on the rear side of the transparent plastic layer.

Furthermore, from EP 0 774 365 B1 a method of production for board-like sliding devices is known, in which likewise an outer, multi-layered decoration complex is prefabricated and subsequently bonded to the support structure of the board-like sliding device. To produce the decoration complex a decoration is transferred by the method of imprinting sublimable inks onto a transparent or light-permeable plastic layer. Afterwards, a contrast film is adhered under heat and pressure onto the surface of the plastic layer previously decorated with sublimable inks. To achieve the finished state of the board-like article the said prefabricated, multi-layered decoration complex is applied under heat and pressure onto the actual reinforcement structure of the board-like sliding device, whereby the active temperature and pressure values are greater than the temperature and pressure values necessary for obtaining the decoration complex. Also in this case there is a multiple thermal loading of the transparent, outer plastic layer or sublimable inks.

U.S. Pat. No. 5,292,148 A and U.S. Pat. No. 5,496,053 A show generic sliding board bodies, in particular skis, in which a structural combination of a shell or cap construction is provided in connection with at least one side wall element, which extends at least within the binding assembly section of the ski. How such a sliding board body should be created is not described in these documents. Such constructions are relatively expensive and prone to error when using standard procedures to produce multi-layered sliding board bodies.

### BRIEF SUMMARY OF THE INVENTION

The underlying objective of the present invention is to provide a method for the production of a sliding board body, in particular a ski or snowboard with a combined shell and side wall construction, which enables as far as possible an inexpensive and error-free production sequence for creating high quality sliding board bodies.

The objective of the invention is achieved by way of a procedure according to the features of claim 1. An advantage of the measures of claim 1 is that a multi-layered or multi-part sliding board body can be created, which can be produced despite a structurally relatively complex structure comprising a so-called shell or cap construction in combination with at least one side wall element, relatively inexpensively and reliably in production, in particular meeting high quality criteria. In addition, the method according to the invention enables a variable but still relatively inexpensive production of sliding board bodies in partial shell or cap-construction in technical combination with at least one side wall element extending partially in longitudinal direction of the sliding board body and designed as an independent component. In particular, the prefabrication of the upper limiting element comprising the cover layer, at least one element of the strengthening top band and at least one strip-like side wall element enables a stable and inexpensive and high quality production of sliding board bodies in a subsequent production cycle. In addition, by way of the connection of the at least one side wall element with the cover layer or with the lower band in a separate or independent method step as far as possible a reproducible or intentional coupling between the cover layer and the respective side wall element is ensured. In addition, by way of the connection between the cover layer and the at least one side wall element in a separate production step, which is prior to the connection of the preprepared components of the whole sliding board body, as far as possible an exact and permanent connection is formed between the said elements. In particular, in this way fiddly individual parts or positionings, which require a high degree of positioning precision, are largely avoided, whereby stable and high-quality production processes are created which can also be completed and executed in a relatively short period of time.

Furthermore, a procedure according to the features described in claim 2 is advantageous, as in this way a perfect connection with the remaining or final components of the sliding board body to be produced is made possible. In particular, in this way an intended contour or shaping of the sliding board body to be produced is ensured to a large extent. In addition, the unwanted decomposition or delamination of the outer limiting element created in the preceding method step are avoided or lessened. Mainly, delamination processes of a side wall element relative to the cover layer or relative to the lower band can be reliably avoided or prevented in this way, since owing the preshaping of the upper limiting element excessive tear off or removal forces can be minimized or avoided between the cover layer and the at least one side wall element.

By means of the further measures according to claim 3 in a simple manner a side wall element is created which corresponds to the respective geometric conditions and the respectively required and desired strength or bending resistance properties. Furthermore, in this way a plurality of technically and/or optically different side wall elements can be adapted in a simple and inexpensive manner to the respective needs and requirements.

Also the measures according to claim 4 are particularly advantageous, as in this way production-defined tolerances can be easily balanced out to a specific extent. Furthermore, the tightness of the composite body to be produced by a hot pressing procedure from the unwanted escape of flowable hot-fusible adhesive or gradually hardening plastic is improved effectively. Furthermore, the tightness of the composite body with regard to avoiding the unwanted penetration of water into the structure of the composite body is achieved reliably. Last but not least, by means of this at least one damping layer the transmission of impact or high-frequency vibrations from the running surface section of the sliding board body in the direction of its surface is reduced, so that a correspondingly produced sliding board body can meet increased requirements of comfort and quality.

Furthermore, a procedure according to the features described in claim 5 is advantageous, as in this way the final, intended shaping and the definition of the outline contour of the sliding board body can be performed in a separate method step relatively exactly according to the reference values and according to the intended geometric data. An essential advantage of this measure is that during the creation of the upper, prefabricated limiting element small or easily fulfilled requirements relating to the positioning precision between the at least one side wall element and the cover layer are defined, so as to support a production process that is as inexpensive as possible. In particular, also with relatively high positioning tolerances between the cover layer and the at least one side wall element in the end or as a result highly precise sliding board bodies are created which correspond to the respective geometric reference values.

A further advantageous measure is described in claim 6, as thereby also spatially and geometrically relatively complex contours and cross sections can be created and a high reproducibility or quality of the correspondingly produced sliding board body can be achieved. In addition, it is ensured in this case that the side wall elements can be supported on the inner mold surfaces of the hot pressing device, so that the risk of destruction or damage to the adhesive connection between the side wall elements and the cover layer or the top band, for example as a result of the injection or expansion pressure of the foamed plastic, is low or is virtually eliminated.

Furthermore, a procedure according to claim 7 or 8 is an advantage, as in this way an upper limiting element is created, which comprises a plurality of components joined together in one piece, which are advantageous for the production of a board-like winter sports device. In particular, by way of the measure of also adhering the core element to the lower side of the top band in preparation, the production of a sliding device with a technically combined shell-side wall construction is as faultless as possible and at the same time inexpensive. In addition, in this way an outer limiting element is created in this way which is prefabricated and also relatively simple to manipulate. In particular, the core element connected to the cover layer or the top band stabilizes the cover layer, so that a relatively robust, prefabricated component is created, which simplifies the handling as part of the later connecting process to the remaining components of the sliding board body to be produced.

Furthermore, the measures according to claim 9 are particularly advantageous, as in this way the cost-effectiveness and also the quality of a production process for a sliding board body, in particular for a board-like winter sports device, can be improved significantly even further. In particular, only one additional hot pressing procedure is required in order to complete the correspondingly prefabricated semi-finished product into a corresponding composite body, which also comprises the outer limiting element in connection with the core element, which composite body in addition comprises the running surface and possibly edge elements and defines the structural base for the sliding board body to be produced.

Lastly, the objective of the invention is also achieved by way of the measures according to claim 10. In particular, in this way sliding board bodies can be created with a structurally combined shell and side wall construction, which can be produced as inexpensively as possible and thereby correspond to high quality criteria.

### BRIEF DESCRIPTION OF THE DRAWINGS

For a better understanding of the invention the latter is explained in more detail with reference to the following figures.

In a much simplified schematic representation:

FIG. 1 shows a method step for producing a prefabricated, upper limiting element for a generic sliding board body;

FIG. 2 shows a subsequent method step to FIG. 1, which comprises the adhesive connection of the cover layer or top band with at least one side wall element;

FIG. 3 shows a method step in which the prefabricated, upper limiting element is connected by means of a hot pressing device with the additional components of the composite body or the later sliding board body;

FIG. 4 shows a method step comprising the subsequent processing of the side flanks of a generic sliding board body;

FIG. 5 shows a sliding board body produced according to the method of the invention, in particular a ski, in side view;

FIG. 6 shows a method step which illustrates the production of the prefabricated, upper limiting element in combination with a core element;

FIG. 7 shows a method step similar to FIG. 6 in combination with a multipart side wall element;

FIG. 8 shows the prefabricated outer limiting element according to FIG. 7 inside a hot pressing device during the connection with the remaining or additional components of the sliding board body to be produced.

### DETAILED DESCRIPTION

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

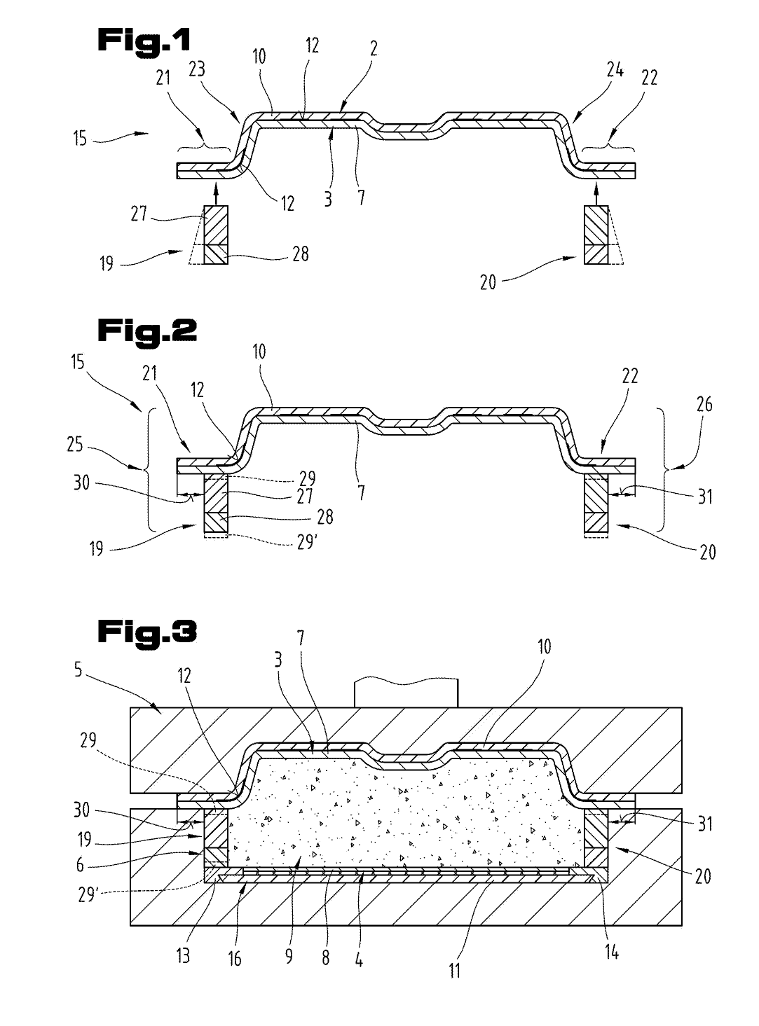

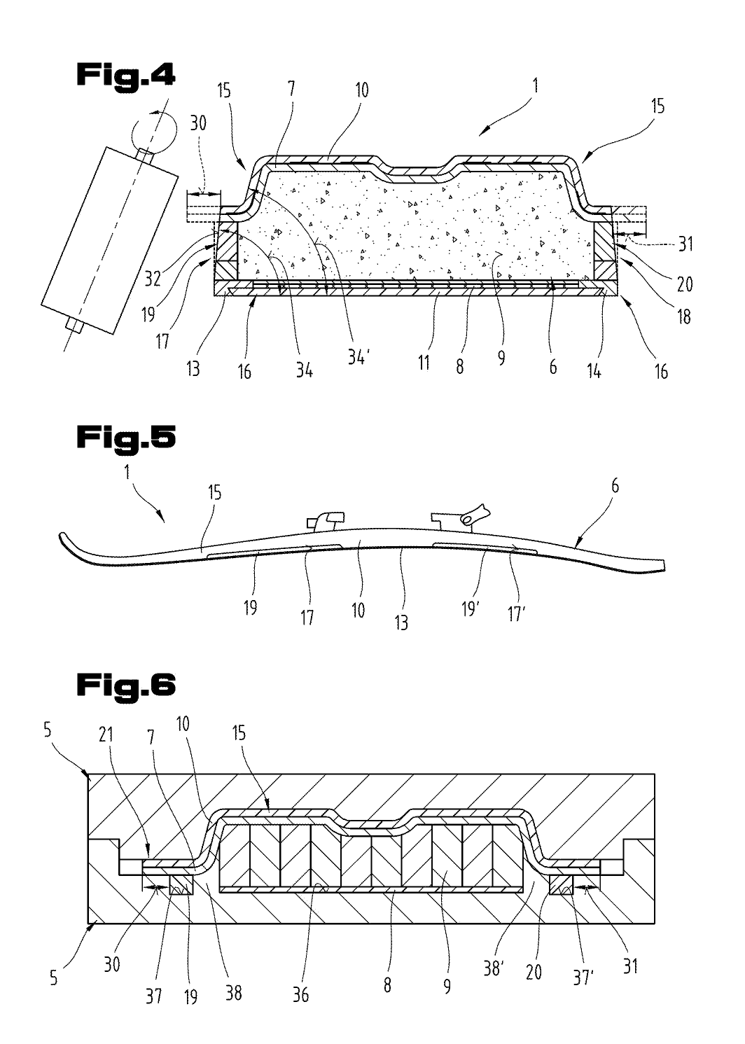

In FIGS. 1 and 2 an advantageous method is illustrated schematically comprising the steps according to the invention for the production of a sliding board body 1, as shown in part in FIGS. 3 and 4.

FIG. 3 represents in this case several production steps known from the prior art for creating a sliding board body 1 according to the foam-injection method (RIM; Reaction Injection Molding). In this case strengthening and also decorative layers 2, 3, 4 are joined together and adhered by using gradually hardening foamed plastic, in particular PU-foam, by means of a hot pressing device 5 in a hot pressing cycle into a one piece composite body 6—FIG. 3, 4.

The strengthening layers 3, 4 comprise essentially a top band 7 and/or a lower band 8 for the composite body 6. This so-called banding can be formed in this case by metal layers and/or by a so-called “prepreg” in the form of resin-soaked mats or the like. Depending on the desired mechanical properties, such as e.g. the shaping properties or strength properties, optionally only one top band 7 or only one lower band 8 can be provided.

At least one core element 9 of the composite body 6 is formed between the top band 7 and the lower band 8, as already known. Said core element 9 can, as already known, be formed by a foamed plastic. According to the embodiments described in more detail below the core element 9 is made from a wooden material, in particular from several strips of wood glued together.

In an initial method step an outer cover layer 10 and if necessary a running surface 11 is chosen from a plastic material, which is at least partially transparent or translucent. The cover layer 10 and/or the running surface 11 is provided prior to the production process of the composite body 6 on at least one flat side with a decoration or imprint 12, preferably according a sublimation method or thermodiffusion coloring method known from the prior art. To achieve increased mechanical protection of the imprint 12 it is of course expedient, to attach the latter onto the rear side of the cover layer 10 and/or the running surface 11.

If the composite body 6 is to be used as an alpine ski or snowboard, the running surface 11, as already known, can be allocated lateral edge elements 13, 14, preferably made of metal, in order to improve the guiding of the sliding board body on snow and ice. In particular, during the production of cross-country skis said edge elements 13, 14 can also be omitted.

At least the cover layer 10 is an outer, upper limiting element 15 of the composite body 6, since the cover layer 10 forms at least one part section of the outer surface of the sliding board body 1. However, also the running surface 11 represents an additional outer limiting element 16 of the sliding board body 1, since the flat side of the running surface 11 facing away from the core element 9 forms the ground-side or lower surface, in particular the running surface of the sliding board body 1.

The method according to the invention relates to the production of the upper or cover-side outer limiting element 15 for a generic sliding board body, such as a ski or a snowboard. Said upper, production technically prefabricated limiting element 15 is formed by a one-piece part component comprising at least the cover layer 10 and at least one component of the strengthening top band 7. Said production technically prefabricated, upper limiting element 15 is connected in a following method step or in a separate production cycle to the additional components of the sliding board body, such as for example with its running surface 11 and with its strengthening lower band 8.

It is essential that an upper limiting element 15 is prefabricated or prepared for the sliding board body 1 to be produced subsequently, which in addition comprises at least one strip-like side wall element 19, 20 forming a lateral wall section 17, 18 of the sliding board body 1. In particular, the upper limiting element 15 in a separate method step prior to joining with the remaining components of the sliding board body 1 is connected to at least one strip-like side wall element 19, forming a lateral wall section 17, 18 of the sliding board body. In this case the at least one strip-like side wall element 19, 20 is adhered to at least one longitudinal side edge 21, 22 of the cover layer 10 or to the top band 7 arranged on the lower side of the cover layer 10, as can be taken mainly from the exemplary, schematic representations according to FIGS. 1, 2. This means that the cover layer 10, at least one part of the top band 8 and at least one strip-like wall element 19, 20, which forms the so-called side wall of the subsequent sliding board body 1, is a preprepared or preproduced composite element, which in a following method step is connected to the other components of the sliding board body 1 to be produced—FIG. 4.

It is also preferable, to transfer the prefabricated limiting element 15, which comprises at least the cover layer 10, at least one part of the strengthening top band 7 and at least one strip-like side wall element 19, 20, prior to the connection with the additional components of the sliding board body 1 into an approximately U-shaped cross-sectional shape. This can be accomplished by suitable press shaping or other shaping methods. Said shaping process is performed such that the lateral, longitudinal edge sections 23, 24 of the cover layer 10 together with the strip-like side wall elements 19, 20 assigned to the latter form the so-called arms 25, 26 of the limiting element 15 that is essentially U-shaped in cross section. By comparison the so-called base of the essentially U-shaped limiting element 15 is defined by the central section or by the longitudinal middle section of the cover layer 10, as best shown in FIG. 2. The shaping process and the adhesive process in relation to said composite element, which comprises at least the cover layer 10 and preferably at least two edge side wall elements 19, 20, is performed preferably at least almost approximately at the same time as the adhesion of the said elements, which is preferably performed with the aid of a molding press with or without heating.

According to an advantageous method step at least one strip-like side wall element 19, 20 can be formed by adhering at least two strip-like plastic profiles 27, 28 arranged on top of one another. In particular, by means of two plastic profiles 27, 28 arranged on top of one another the most advantageous shaping or cross sectional height of the at least one side wall element 19, 20 of the sliding board body 1 can be adjusted in a simple manner to the respective requirements or geometric ratios and/or the respectively desired strength properties.

Preferably, for each longitudinal side wall of the sliding board body 1 at least one side wall element 19, 20 is formed, which is designed to be physically independent and different in comparison to the cover layer 10, as shown by way of example in FIG. 4. If necessary, it is also possible, on a least one longitudinal side wall of the sliding board body 1 in relation to its longitudinal direction to have two or more side wall elements 19, 19′ arranged behind one another, whereby between side wall elements 19, 19′ arranged behind one another preferably a predefined spacing is provided, as shown by way of example in FIG. 5. Within this spacing between side wall elements 19, 19′ or 20, 20′ arranged behind one another the cover layer 10 is preferably pulled downwards up to the upper side of the edge elements 13, 14, so that in this case the cover layer 10 is supported on the upper side of the edge elements 13, as far as possible directly and in a load-transferring manner.

According to a further measure the at least one striplike side wall element 19, 20 during the production of the prefabricated upper limiting element 15 can be provided on its lower and/or upper side with a damping layer 29, 29′, in particular adhered, as indicated by dashed lines in FIGS. 2, 3. Said damping layer 29, 29′ consists of an elastomer plastic, which compared to the plastic of the side wall element 19, 20 is designed to be comparatively flexible and elastically restoring. Said damping layer 29, 29′ is used for damping vibrations, which are transferred from the edge element 13, 14 to the top band 7 or onto the cover layer 10 and then onto the foot of a user of the sliding board body. However, also production technical tolerances can be compensated by said damping layer 29, 29′, so that as far as possible the inexpensive production of sliding board bodies 1, in particular alpine skis, snowboards or cross country skis, is made possible and it also meets demands for high quality. An additional significant advantage of this development is that an improved tightness of the composite body 6 is achieved, which on the one hand has a positive effect with regard to avoiding or reducing the penetration of water into the inner structure of the sliding board body 1, but is also advantageous with respect to avoiding or reducing the escape of adhesive, for example PU-foams and/or plastic resins, which during the adhesion of the prefabricated, upper limiting element 15 to the additional components of the sliding board body 1, in particular its lower limiting element 16, are in a flowable or viscous state. This means that by means of this damping layer 29, 29′ also the unwanted escape of adhesive is reduced or lessened in an effective manner during the final hot adhesion or compaction of the upper, prefabricated limiting element 15 with the running surface 11 and/or the lower band 8 or with the edge elements 13, 14 from the core section of the composite body 6 in the direction of its outer or upper surfaces. Complex postprocessing or quality-reducing marks or accumulations of adhesive can be minimized or completely avoided in this way.

As can best be seen from an overview of FIGS. 1 to 3 the at least one side wall element 19, 20 is adhered to the respective edge section or longitudinal side edge 21, 22 of the cover layer 10 or the top band 7 during the prefabrication of the upper limiting element 15 such that a lateral protrusion 30, 31 of the cover layer 10 or the top band 7 relative to the outer side or wall surface of the side wall element 19, 20 is formed. In this way a rapid and relatively unproblematic connection, in particular adhesion, can be performed between the cover layer 10 and the underlying top band 7 and the web-like, strip-like side wall element 19, 20. In particular, in this way simplifications in the production can be achieved, since high precision or increased positioning precision is not necessary. According to an advantageous measure, namely after the connection of the multi-part, one-piece limiting element 15 to the additional components of the sliding board body 1, in particular after the injection of a foamed core element 9 or after the hot pressing process with a prefabricated core element 9 and the various components of the lower limiting element 16, the strip-like side wall elements 19, 20 and protrusions 30, 31 of varying size on the longitudinal side edges 21, 22 of the cover layer 10 are cut level or ground level, as best shown from FIG. 4. In particular, the protrusion 30, 31 is eliminated relative to the outside of the adhered side wall elements 19, 20, preferably ground or cut away, after the one piece composite body 6 has been produced, in particular once the composite body 6 produced in a hot pressing cycle has been demolded or removed from the hot pressing device 5.

By means of said cutting or grinding process preferably not only the protrusion 30, 31 is removed, but advantageously also an inclination of the outer side surface 32, 33 of the side wall element 19, 20 is formed relative to a vertical plane and/or surface processing is carried out on the outsides of the side wall elements 19, 20. This means that after the production of the composite body 6 or after the demolding of the latter from the hot pressing device 5 material is removed or a chip—removing process is performed both on the outsides of the side wall elements 19, 20 and also on the longitudinal side edges 21, 22 of the cover layer 10 and the top band 7. Advantageously, an angle of inclination 34, 35 between the surface of the running surface 11 and the outer side surface 32, 33 of the side wall element 19, 20 is between 60° to 85°, preferably about 75°. However, an angle of inclination 34′, 35′ of the part sections or wall sections of the cover layer 10 located above the side wall elements 19, 20 relative to the running surface 11 is comparatively smaller, as best shown from FIG. 4. The angle of inclination 34′, 35′ of the lateral part sections or the lateral wall sections of the cover layer 10 is between 55° to 75°, preferably about 65°. As shown best from FIG. 4, the side surfaces 32, 33 of the side wall elements 19, 20 in connection with the side edge sections of the cover layer 10 form respectively stepped side walls or stepped side wall sections for the sliding board body 1, whereby said stepping or the formation of the side wall elements 19, 20 in relation to the overall length of the sliding board body 1 is simply performed partially. The longitudinal extension of the side wall elements 19, 20 for each longitudinal side of the sliding board body is between 20% to 80%, preferably about 40% of the projected length of the sliding board body 1.

As already explained above, the upper limiting element 15 is at least partly preshaped prior to insertion into the hot pressing device 5, in particular is shaped, such that it has an essentially U-shaped cross sectional shape, as illustrated in FIG. 2 by way of example. The final shaping of the outer limiting element 15 is created however by injecting gradually hardening foamed plastic, in particular by injecting PU-foam at a defined injection pressure, into a hollow or free spaced defined originally between the preprepared limiting element 15, the edge elements 13, 14 and the lower band 8 of the sliding board body 1. This means that also by means of the expansion pressure produced on the hardening of the foamed plastic, but significantly by the injection pressure of the foamed plastic, the outer limiting element 15 is pressed or forced as far as possible over the surface or relatively gap-free against the inner form surfaces of the hot pressing device 5. This means that the final shape of the outer limiting element 15, which comprises at least the cover layer 10 and at least one side wall element 19, 20 running over a partial section of the longitudinal extension of the cover layer 10, is only created during the hot pressing cycle to form the one-piece composite body 6.

FIG. 6 shows an advantageous, further measure for the indicated method for producing the outer limiting element 15 for a sliding board body 1. In this case in addition to the formation of the connection between at least one strip-like side wall element 19, 20 relative to at least one longitudinal side edge 21, 22 of the cover layer 10 or relative to the top band 7 arranged on the lower side of the cover layer 10, also the core element 9 or at least one part of the core element 9 is connected to the upper limiting element 15, in particular by adhesion—in a separate, method or production step prior to the final hot pressing procedure for the complete composite body 6. In particular, the upper, prefabricated limiting element 15 is adhered prior to the connection with the additional components of the sliding board body 1, in particular prior to the connection with the edge elements 13, 14 and with the running surface 11, to the core element 9 of the later composite body 6. The complete composite body 6 is created in at least one separate, later method step and then comprises all of the functionally relevant elements and all of the layers of the sandwich-like sliding board body 1 to be produced.

According to this method the prefabricated or preprepared upper limiting element 15, i.e. at least the cover layer 10, comprises at least one component of the strengthening top band 7, at least one adhesively connected side wall element 19, 20 and also at least one component, preferably the main component, of the core element 9 for the sliding board body 1 to be produced subsequently.

An example of an upper limiting element 15 is shown schematically in FIG. 6 during its production phase, in particular during the hot pressing cycle. It is advantageous in this case that the core element 9 is held in position in a mounting depression 36 of the hot pressing device 5 adjusted at least approximately to the core element 9. Similarly, it is advantageous to position the at least one side wall element 19, 20, which is to be connected, in particular adhered, to the lower side of the cover layer 10 or the lower side of the top band 7, in an adequate, preferably separately designed mounting depression 37, 37′.

By closing or activating the mold halves of the hot pressing device 5 then preferably at the same time or at least almost at the same time at least one side wall element 19, 20 and at least one part of the core element 9 is joined in one piece with the cover layer 10, in particular with the lower side of the top band 7, which is preferably made from a so-called prepreg material. Said connecting process is preferably performed as a hot adhesive process.

Between the mounting depression 36 for the core element 9 and the at least one mounting depression 37, 37′ for the at least one side wall element 19, 20 at least one separating web 38, 38′ is formed, which separates the adjacent mounting depressions 36, 37 and 36, 37′ and preferably also is used as a support element to achieve or secure the desired contour of the cover layer 10 or the top band 7, as shown in FIG. 6. By means of said mounting depressions 36, 37, 37′ on the one hand the core element 9 and on the other hand the at least one side wall element 19, 20 is positioned sufficiently precisely and during the hot pressing process, in particular during the hot adhesive phase, which is performed by using a specific pressure on the cover layer 10 or the resin-based top band 7, is held sufficiently exactly and in a stable position. In this way a stable and as far as possible reproducible and faultless production sequence is achieved.

If necessary, it is also possible to attach in preparation onto the lower side of the core element 9 an adhesive layer and/or a lower band 8 or a component of the later lower band 8, as indicated likewise by way of example in FIG. 6.

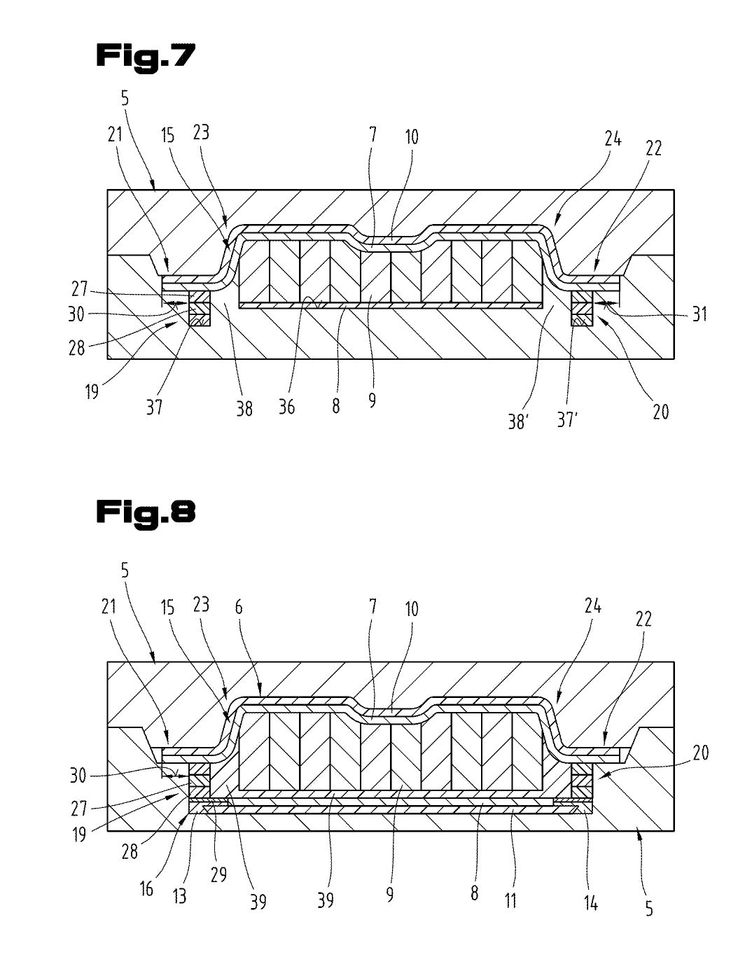

In FIG. 7 an essentially similar production method is illustrated as in FIG. 6. Unlike the embodiment according to FIG. 6 in the embodiment according to FIG. 7 at least one side wall element 19, 20 composed of several individual elements is adhered to the lower side of the top band 7, whereas at the same time or at least almost at the same time also a core element 9 is attached to the lower side of the cover layer 10 or the top band 7. Also in this case, on the one hand, for the core element 9 and, on the other hand, for the at least one side wall element 19, 20 at least one position-determining mounting depression 36, 37, 37′ is formed in the hot pressing device 5, in particular in the lower mold half of the hot pressing device 5. According to an advantageous method the cover layer 10, at least one part of the top band 7, at least one side wall element 19, 20 and the core element 9 are pressed and adhered together during a single, common hot pressing method to form a one piece semi-finished product.

After the removal of said prefabricated limiting element 15 from the hot pressing device 5, at least in the area in which the separating web 38, 38′ was positioned, a hollow or free space is formed, in particular a spacing between the at least one side wall element 19, 20 and the core element 9. Said spacing or said hollow or free space is filled with adhesive in a following method step to form the final composite body 6, in particular adhesive foam, as shown in FIG. 8. In particular, FIG. 8 shows the production step in which the prefabricated, upper limiting element 15 is connected to the remaining additional components of the composite body 6 or sliding board body 1. In this case the prefabricated limiting element 15 is connected in an independent hot pressing cycle to the edge elements 13, 14 and the running surface 11. In this method step an adhesive means, for example a resin-based filler adhesive 39 with a PU base, is introduced or injected into deliberately defined hollow or free space. Said filler adhesive 39 also fills the predefined gap or free space between the at least on side wall element 19, 20 and the side faces of the core element 9, so that a sufficiently stable coupling is provided between the side wall elements 19, 20 and the core element 9. In the same way the filler adhesive 39 is used to connect the lower side of the core element 9 or the lower band 8 to the lower side of the core element 9 with the running surface 11 or with the edge elements 13, 14 in a sufficiently stable or non-removable manner.

After the demolding of the composite body 6 from the hot pressing device 5 the protrusion 30, 31 on the side flanks of the composite body 6 is removed, in particular cut or ground away, as illustrated in the view shown in FIG. 4 by way of example. The correspondingly processed composite body 6 then represents a product that is relatively close to the final state for the formation of the generic sliding board body 1, in particular in the form of a ski or snowboard.

All of the details relating to value ranges in the present description are defined such that the latter include any and all part ranges, e.g. a range of 1 to 10 means that all part ranges, starting from the lower limit of 1 to the upper limit 10 are included, i.e. the whole part range beginning with a lower limit of 1 or above and ending at an upper limit of 10 or less, e.g. 1 to 1.7, or 3.2 to 8.1 or 5.5 to 10.

The exemplary embodiments show possible embodiment variants of the method of production according to the invention and of the sliding board body 1 produced thereby, whereby it should be noted at this point that the invention is not restricted to the embodiment variants shown in particular, but rather various different combinations of the individual embodiment variants are also possible and this variability, due to the teaching on technical procedure, lies within the ability of a person skilled in the art in this technical field. Thus all conceivable embodiment variants, which are made possible by combining individual details of the embodiment variants shown and described, are also covered by the scope of protection.

Finally, as a point of formality, it should be noted that for a better understanding of the structure of the sliding board body 1 the latter and its components have not been represented true to scale in part and/or have been enlarged and/or reduced in size.

The problem forming the basis of the independent solutions according to the invention can be taken from the description.

Mainly the individual embodiments shown in FIGS. 1-2; 3; 4; 5; 6; 7; 8 can form the subject matter of independent solutions according to the invention. The objectives and solutions according to the invention relating thereto can be taken from the detailed descriptions of these figures.

1. A method for producing an outer limiting element for a sliding board body, such as a ski or a snowboard, which limiting element is formed by a one-piece part component assembled from a cover layer and at least one part of the strengthening top band, and which limiting element is connected in a following method step to the additional components of the sliding board body, such as its running surface and its strengthening lower band, wherein the limiting element is connected prior to the connection with the additional components of the sliding board body with at least one strip-like side wall element forming a lateral wall section of the sliding board body, in that the at least one strip-like side wall element is adhered to at least one longitudinal side edge of the cover layer or to the top band arranged on the lower side of the cover layer.

2. The method according to claim 1, wherein the prefabricated limiting element, which comprises at least the cover layer, at least one part of the strengthening top band and at least one strip-like side wall element, prior to connecting to the additional components of the sliding board body is brought into an almost U-shaped cross-sectional shape, wherein lateral edge sections of the cover layer and the strip-like side wall elements assigned to said edge sections form the two arms of the essentially U-shaped limiting element.

3. The method according to claim 1, wherein at least one strip-like side wall element is formed by the adhesion of at least two strip-like plastic profiles arranged on top of one another.

4. The method according to claim 1, wherein the strip-like side wall element on its lower and/or upper side is adhered to a damping layer made from an elastomer plastic.

5. The method according to claim 1, wherein after the connection of the limiting element to the remaining components of the sliding board body the strip-like side wall elements and the longitudinal side edges of the cover layer are cut level or ground level.

6. The method according to claim 1, wherein the final shaping of the outer limiting element is achieved by injecting hardening foamed plastic into a hollow chamber between the prepared limiting element, the edge elements and the lower band or the running surface of the sliding board body.

7. The method according to claim 1, wherein the limiting element prior to the connection to the running surface of the sliding board body is adhered to a core element for the sliding board body to be formed subsequently.

8. The method according to claim 7, wherein the upper cover surface of the core element is adhered to the lower side of the top band facing away from the cover layer.

9. The method according to claim 7, wherein the cover layer, at least one part of the top band, at least one side wall element and the core element are pressed together and adhered during a single, joint hot pressing procedure into a one-piece semi-finished product.

10. A method for producing a sliding board body, such as a ski or a snowboard, in which a plurality of elements comprising a cover layer, a strengthening top band, a strengthening lower band, a running surface and at least one side wall element are joined adhesively to one another by at least one hot pressing process, wherein an outer limiting element produced according to the preceding claims is prepared and said prefabricated limiting element is joined in at least one following, separate hot pressing cycle to the additional components of the sliding board body to be produced, such as its running surface and its strengthening lower band.
